(19) United States
(12) Patent Application Publication
(10) Pub. No.: US 2017/0049054 A1
(43) Pub. Date: Feb. 23, 2017

(54) DEVICE FOR HARVESTING VEGETABLE PLANTS FROM THE LAND

(71) Applicant: Tumoba B.V., BARENDRECHT (NL)

(72) Inventor: Hendrik Willem MOLENAAR, BARENDRECHT (NL)

(21) Appl. No.: 15/242,887

(22) Filed: Aug. 22, 2016

(30) Foreign Application Priority Data
Aug. 20, 2015 (NL) 1041439

(51) Int. Cl. A01D 45/00

(52) U.S. Cl. CPC A01D 45/00

(57) ABSTRACT

Device for harvesting vegetable plants from the land, includes:
a frame;
first and second conveyors arranged on the frame, the conveyors positioned a conveyance track conveying vegetable plants that have been separated from the land to one or more processing stations;
the first and second conveyors each including a series of links, wherein the links within a series are connected to each other by first hinged connections;
the links having clamping surfaces, which in the conveyance track the clamping surfaces of the first and second conveyors face each other for keeping the vegetable plants, clamped in between them in an intermediate space formed by the opposing clamping surfaces of the links of the first and second conveyors,
the conveyance track, the links of at least one of the conveyors being resiliently movable relative to the frame in a direction transverse to the clamping surfaces.

### BACKGROUND OF THE INVENTION

The invention relates to a device for mechanically harvesting vegetable plants having a stem and a crown, in particular broccoli.

Known from among others European patent application 1.894.464, is a harvesting machine for broccoli having two circularly driven link conveyors, which clamp the broccoli stems in between them in a conveyance track and pass the broccoli plants through a number of processing stations. The broccoli plant is first received in a feeding station, when situated between both conveyors and clamped by them. The relative speed of the conveyors relative to the ground is then zero. Subsequently the plant stem is severed in order to detach the plant, the cut-off broccoli plant is then turned upside down, subsequently the crown is positioned at a wanted level, the leaves hanging below the conveyors are cut off and discharged, the crown of the clamped stem is cut off and discharged, and finally the stem is released and discharged. The conveyors then pass through a return track towards the feeding station.

The conveyors consist of metal links, capable of hinging relative to each other about several axes that are perpendicular to each other. The links, with turned lips, are guided into hard, wear-resistant synthetic guides that are permanently attached to the frame of the harvesting machine. On the clamping side the links have a plate, which is covered by a strip of foam rubber material continuing over the links and forming the clamping surface. The stem of the broccoli plant is thus clamped between two opposing strips of foam rubber material, in a resilient manner, wherein small deviations in the stem thickness do not affect the holding power.

In case of larger differences in thickness between the stems, the resilient strips may, however, not be thick enough in order for them to be sufficiently pressed in. Furthermore, in case of larger stem thicknesses the force with which the links are pushed against the guide may become too great, as a result of which failures may arise. Finally, the foam rubber material is prone to wear and tear and needs to be replaced regularly.

### SUMMARY OF THE INVENTION

According to one aspect, the invention provides a device for harvesting vegetable plants from the land, in particular vegetable plants having a stem, more in particular vegetable plants having a stem and a crown, such as broccoli, comprising:
a frame;
first and second conveyors arranged on the frame, which conveyors have been positioned for in a conveyance track conveying vegetable plants that have been separated from the land to one or more processing stations for said vegetable plants;
wherein the first and second conveyors each comprise a series of links, wherein the links within a series are connected to each other by first hinged connections;
wherein the links have clamping surfaces and in the conveyance track the clamping surfaces of the first and second conveyors face each other for keeping the vegetable plants, in particular their stems, clamped in between them in an intermediate space formed by the opposing clamping surfaces of the links of the first and second conveyors,
wherein in the conveyance track, the links of at least one of the conveyors are resiliently movable relative to the frame in a direction transverse to the clamping surfaces.

In that way the possible, wanted deformation area is transferred from the clamping side of the links to elsewhere, as a result of which the size of the deformation path does not have to be limited by the distance between the opposing links, which distance in the state of the art is fixed during conveying the vegetable plants. In that way a wide range of plant thicknesses and/or stem thicknesses can reliably be clamped between the two conveyors. Furthermore, the clamping surfaces can be available for other aids, such as the orienting members to be discussed later on.

In the conveyance track, in the area between the links and the frame, the resilient movability of the links relative to the frame may have been provided by spring devices that have been arranged for in a resilient manner pushing the opposing clamping surfaces of the links of the first and second conveyors in a direction towards each other.

In one embodiment the links of only one of the first and second conveyors are resiliently movable towards the other and/or away from the other. In another embodiment the links of both conveyors are resiliently movable towards each other and/or away from each other.

The links may have been provided with guiding members, wherein the device further comprises first and second guides for guiding the guiding members of the links of the first and second conveyors, respectively.

In one embodiment, when considered in conveyance direction, the spring devices are relatively stationary with the respective one of the first and the second guides. The links per se moving in the conveyance direction can then be free of spring devices required for the wanted deformation, so that the conveyor in question can be kept simple and less failure-prone in that respect.

In one embodiment thereof the spring devices can for instance be situated on the guides and be in contact with the links.

In an alternative embodiment, which is currently more preferable, the spring devices are active between the frame and the respective one of the first and second guides (meaning: either the first guide, or the second guide, or both guides). In that case the spring devices can remain free from contacting parts that move during conveying, in particular the links and thus keeping wear and tear within limits to a large extent. Moreover, relatively large spring travel lengths can thus be achieved. The respective one of the first and second conveyors can be arranged on first and second frame parts, respectively, which parts are situated on the side of the respective one of the first and second conveyors, which side faces away from the intermediate space, wherein the spring devices are active between the respective one of the first and the second frame parts and the respective one of the first and the second guides, respectively.

In one embodiment, in a condition in which no vegetable plants are being conveyed, the width of the intermediate space between the opposing clamping surfaces of the links of the first and second conveyors is nil, in which situation the clamping surfaces of both conveyors will then be able to contact each other. In one development the minimum width of the intermediate space between the opposing clamping surfaces of the links of the first and second conveyors is adjustable, in order to be able to adjust the intermediate space when changing the type of crop to be harvested. The range of operation of the spring devices can be bounded by stops for that purpose, which stops preferably are adjustable for adjusting the spring action. The stops may define a minimum width for the intermediate space.

In one embodiment the spring devices are adjustable for providing the desired clamping force. For instance, in an area of the conveyance track in which a relatively smaller or larger clamping force is wanted than elsewhere in the conveyance track, a spring having a lower or higher spring force, respectively, can be accommodated in the spring device(s) in question.

In a simple embodiment the spring devices comprise springs. Pull springs are an option, compression springs are preferred due to the possibly simpler construction. The springs can be parallel to rods that are concentric with the springs, for orienting and guiding the springs, the rods preferably being pins accommodated in the springs. Alternatively, for orienting and guiding the springs, the springs can be surrounded by telescopic tubes, cylinders.

The first and/or second frame parts can each comprise a beam extending parallel to the first and second conveyors, respectively, wherein the spring devices comprise pairs of springs that have been arranged adjacent to each other, on both sides of the beam of the frame part in question.

In a further development of the device according to the invention, in the conveyance track, when considered in conveyance direction, the first and/or the second guides have been divided into consecutive guide sections, wherein the consecutive guide sections are connected to each other by second hinged connections, wherein the hinge axes of the second hinged connections and the hinge axes of the first hinged connections of the links present at the location of the second hinged connections in question are at least almost parallel to each other. In that way the intermediate space is able to adapt to the thickness of the plant to be clamped and conveyed at that moment, which thickness may differ from the one of the preceding or trailing plant. The mutual distance between the second hinged connections preferably is adapted to the usual distance between the consecutive plants in a row on the land.

In one development thereof, the guide sections of the first and/or the second guides each comprise guide elements and holders for them, wherein the second hinged connections have been arranged between consecutive holders. In that way the materials used can be differentiated between, a suitable guiding and wear-resistant synthetic material for the guiding elements, a constructive material, for instance steel, for the holders.

In one embodiment several of the sections mentioned, preferably all sections mentioned, of the first and/or the second guides have each been connected to the frame by means of a spring device of their own. This enhances the local adaptation of the conveyors.

In one embodiment, the spring devices comprise first spring devices which are active between the frame and the first guide and second spring devices which are active between the frame and the second guide, wherein the first and second spring devices are arranged on opposite sides of the conveyance track and in line with one another.

In one embodiment the conveyance track comprises a curve section, in which the first and second clamping surfaces follow curved paths in mutually parallel planes. If the spring devices are active between the guides and the frame, it may be so that the guides have a degree of freedom to tilt in a plane perpendicular to the local conveyance direction. Said tilting may be the result of a centripetal force exerted on the first and second guides by the moving first and second conveyors. For keeping the first and second guides straight relative to each other, and thus keeping the opposing clamping surfaces straight as well, extra connections may have been arranged between the first and/or the second guides and the frame. Preferably they are situated on the convex side of the curving track, in the form of a tensile connection, where more room will be available and a reduced risk of conflict with plant parts, such as leaves. The extra connections preferably are adjustable.

In a device according to the invention the clamping surface of the links is available for other functions apart from spring action (EP 1.894.464). The clamping surfaces per se can be shape-retaining during normal usage, such as uncoated metal plate links, or be coated with a thin layer of soft, elastic material that can be pressed in, for preventing damage to the plant stems, should there be such a risk and such risk be undesirable.

Should the variation in plant thicknesses/stem thicknesses to be clamped be large, and the spring devices according to the invention be incapable of providing sufficient spring travel length, a thicker layer of elastic material that can be pressed in could, if required, be arranged on the clamping side of the links, to supplement the spring action according to the invention.

In one development the links of at least one of the conveyors at the side of its clamping surfaces, preferably on the clamping surfaces, have been provided with protrusions projecting into the intermediate space, for orienting the stems, the protrusions preferably extending transverse to the conveyance direction. In that way a possibly askew position of a stem can be corrected during accommodating said stem in the intermediate space and thus reduce the risk of failures. In a simple embodiment the protrusions are ribs. In another embodiment the protrusion is a series of projecting elements arranged in line with each other.

In one embodiment the protrusions have been provided on one of either conveyors only, as a result of which an even clamping surface remains present on one side of the intermediate space, which enhances correcting the orientation of the stems.

According to a further aspect, the invention provides a device for harvesting vegetable plants from the land, in particular vegetable plants having a stem, more in particular vegetable plants having a stem and a crown, such as broccoli, comprising:
a frame;
first and second conveyors arranged on the frame, which conveyors have been positioned for in a conveyance track conveying vegetable plants that have been separated from the land to one or more processing stations for said vegetable plants, said processing stations being arranged on the frame;
wherein the first and second conveyors each comprise a series of links, wherein the links within a series are connected to each other by first hinged connections;
wherein the links have clamping surfaces and in the conveyance track the clamping surfaces of the first and second conveyors face each other for keeping the vegetable plants, in particular their stems, clamped in between them,
wherein the links have been provided with guiding members, wherein the device further comprises first and second guides for guiding the guiding members of the links of the first and second conveyors, respectively,
wherein in the conveyance track the first and second guides have been divided into guide sections, when considered in conveyance direction, wherein the consecutive guide sections are connected to each other by second hinged connections, wherein the hinge axes of the second hinged connections and the hinge axes of the first hinged connections of the links present at the location of the second hinged connections in question are at least almost parallel to each other.

In one embodiment, the guide sections of the first and/or the second guides comprise guide elements and holders for them, wherein the second hinged connections have been arranged between consecutive holders.

In one embodiment spring devices, in particular springs, more in particular compression springs, are active between the frame and the first and second guides, for in a direction transverse to the clamping surfaces resiliently holding the first and second guides so that in the conveyance track the links of the conveyors are resiliently movable relative to the frame in a direction transverse to the clamping surfaces.

In one embodiment, the first and/or the second conveyors have been arranged on first and/or second frame parts, respectively, that are situated on the side of the respective one of the first and second conveyors, which side faces away from the intermediate space, wherein the spring devices are active between the respective one of the first and second frame parts and the respective one of the first and second guides, respectively.

In one embodiment, several of the sections mentioned, preferably all sections mentioned, of the respective one of the first and second guides have each been connected to the frame by means of a spring device of their own.

In a further development the device according to the invention comprises a positioning station for positioning the crown of the vegetable plants at the wanted level relative to the conveyors, wherein at the positioning station the conveyance track comprises a positioning sub-track, where the intermediate space between the opposing clamping surfaces is enlarged relative to sub-tracks of the conveyance track that are situated upstream from the positioning station, for allowing a movement of the vegetable plants at that location in stem direction and/or where the resilience of the spring devices is lower than the resilience of the spring devices in sub-tracks of the conveyance track that are situated upstream from the positioning station.

The device according to the invention may furthermore comprise a leaf-cutting station and/or a crown-cutting station situated downstream from the positioning station, wherein at the leaf-cutting station the conveyance track has a leaf-cutting sub-track and at the location of the crown-cutting station has a crown-cutting sub-track, at which locations the width of the intermediate space between the opposing clamping surfaces is smaller than in the positioning sub-track, for keeping the stems clamped and/or at which locations the resilience of the spring devices is greater than the resilience of the spring devices in the positioning sub-track.

In said sub-tracks the arrangement including spring devices according to the invention has advantageously been used again.

In one embodiment the conveyance track comprises a horizontally extending feeding sub-track, an upwardly curved ascending sub-track and a horizontally extending processing sub-track, wherein the processing sub-track preferably is situated straight above the feeding sub-track. The conveyance track is then substantially U-shaped in side view.

At the location of the feeding sub-track a stem-cutting station may have been arranged on the frame, for severing the stem in order to separate the vegetable plant from the land.

A positioning station, a leaf-cutting station and a crown-cutting station may have been arranged on the frame at the location of the processing sub-track.

The conveyors each may have a return track that is substantially parallel and opposite to the conveyance track.

According to a further aspect, the invention provides a device for harvesting vegetable plants having a stem and a crown from the land, comprising a frame, first and second conveyors arranged on the frame, which conveyors have been positioned for in a conveyance track conveying vegetable plants that have been separated from the land to one or more processing stations for said vegetable plants, said processing stations being arranged on the frame, wherein the first and second conveyors each comprise a series of links, wherein the links within a series are connected to each other by first hinged connections, wherein the links have clamping surfaces and in the conveyance track the clamping surfaces of the first and second conveyors face each other for keeping the stems of the vegetable plants clamped in between them in an intermediate space formed by the opposing clamping surfaces of the links of the first and second conveyors, and wherein the links of only one of the conveyors at the side of its clamping surfaces, preferably on the clamping surfaces, have been provided with protrusions, in particular rib-shaped protrusions, extending into the intermediate space, for orienting the stems transverse to the conveyance direction. In one embodiment the protrusion is a series of projecting elements arranged in line with each other.

The conveyors can be so-called linked belts, having plate-shaped links.

The aspects and measures described in this description and the claims of the application and/or shown in the drawings of this application may where possible also be used individually. Said individual aspects may be the subject of divisional patent applications relating thereto. This particularly applies to the measures and aspects that are described per se in the sub claims.

### BRIEF DESCRIPTION OF THE DRAWINGS

The invention will be elucidated on the basis of an exemplary embodiment shown in the attached drawings, in which:

FIG. 1 shows a schematic side view of an exemplary embodiment of a device according to the invention;

FIG. 2 shows a folded-out view of a conveyor in the device of FIG. 1;

FIGS. 3A-C show an end view of the conveyor of FIG. 2, a cross-section according to arrow IIIB in FIG. 3A and a view according to arrow IIIC in FIG. 3A, respectively; and

FIG. 4 shows a view of the conveyor of FIG. 2, during conveying.

### DETAILED DESCRIPTION OF THE DRAWINGS

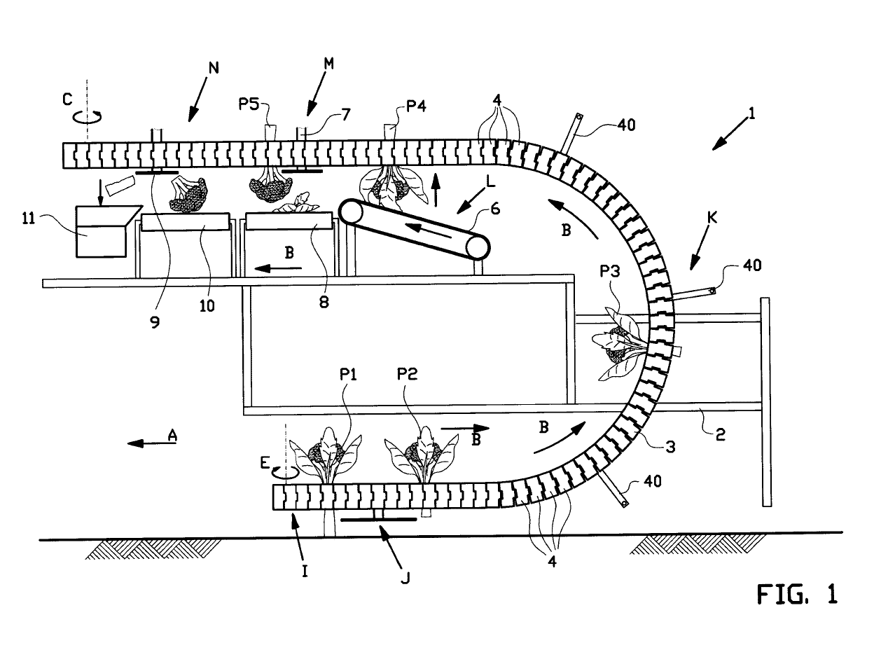

The exemplary embodiment 1 shown in FIG. 1 comprises a frame 2, schematically shown, that can be coupled to a vehicle, such as a tractor (not shown). The parts to be discussed of the device 1 have been attached directly or indirectly to the frame 2.

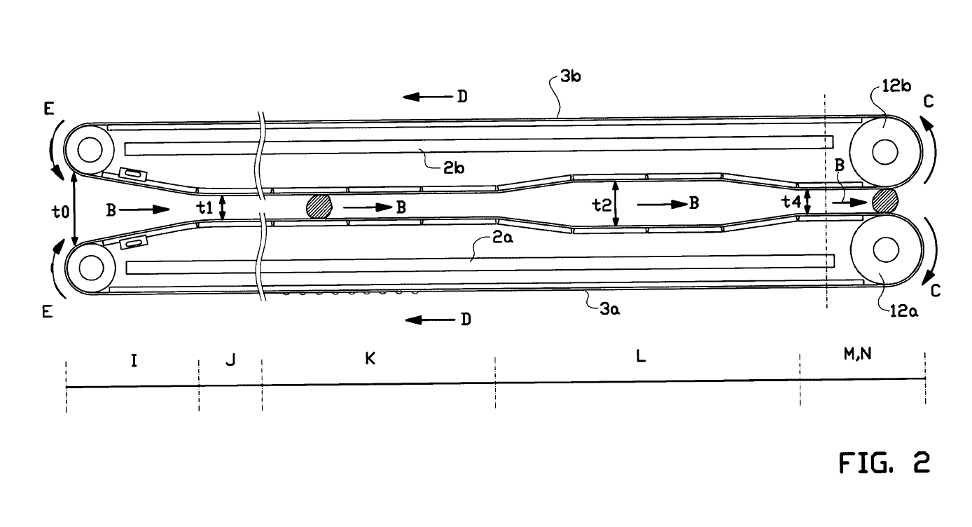

Thus supported on the frame 2 is a conveyor 3, comprising first and second conveyors 3a,b having links 4, which conveyors 3a,b are parallel to each other and each are synchronously driven in order to run according to a conveyance track B up to the upper end 12a, at which location they are turned, direction C, are passed back again parallel to the conveyance track, in opposite direction D, in a return track to lower end 12b, to be turned again at the lower end, direction E, towards the conveyance track, also see FIG. 2.

FIG. 1 schematically shows a number of processing stations. At the lower end 12b there is a feeding station I for the vegetable plants P, in this case broccoli. The feeding station I is followed by a cutting station J, where the plants P are severed close to the ground by a blade 5. Subsequently, for instance after 80 cm, a curving track K follows, for instance having a 50 cm radius, in which the conveyor 3 turns around in upward direction, over 180 degrees, wherein the plants P are turned upside down. Successively positioned in the upper track, of for instance 1.4 m, are a lifting or positioning station L, having ascending belt 6, a leaf-cutting station M, having blades 7 and a transverse discharger 8, a crown-cutting station N, having blade 9 and transverse discharger 10, and a transverse discharger 11 for stem remnants.

The said conveyors and other moving parts are driven by motors that are not further shown, supported on the frame 2.

When in use, the device 1 can be moved onwards in the direction A, wherein the conveyors 3a,b are driven at a speed equal thereto, for instance 1 to 2 m/s.

FIG. 2 schematically shows first and second frame parts 2a,b, on which the first and second conveyors 3a,b are supported. It can be seen that at the location of the feeding station I the conveyors 3a,b converge from broad intermediate space t0 for entering the plants P1 to intermediate space t1, where the plants P2 are cut loose and the severed plants P3 can be clamped between both conveyors 3a,b during the conveyance in direction B. At the location of the lifting or positioning station L, above the ascending belt 6, the conveyors 3a,b diverge to an intermediate space t2, to leave the stem of the plants P (optionally including leaves) sufficiently free to allow the belt 6 to push the plant P4 upwards. In that way the plant crowns are all put at the same level. Subsequently the conveyors 3a,b converge again to an intermediate space t4 where the stem of the plants P5 is sufficiently clamped again for successively passing through the leaf-cutting station M and the crown-cutting station N. At the location where both conveyors 3a,b diverge again at the upper end 12a, the remnant of the stem is released as well to fall onto the discharger 11.

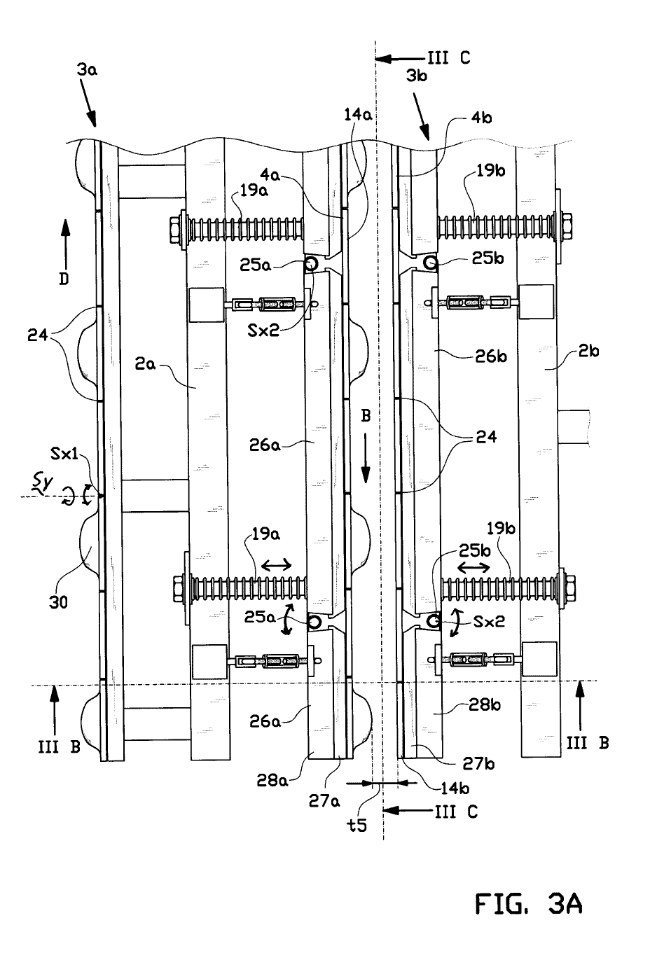

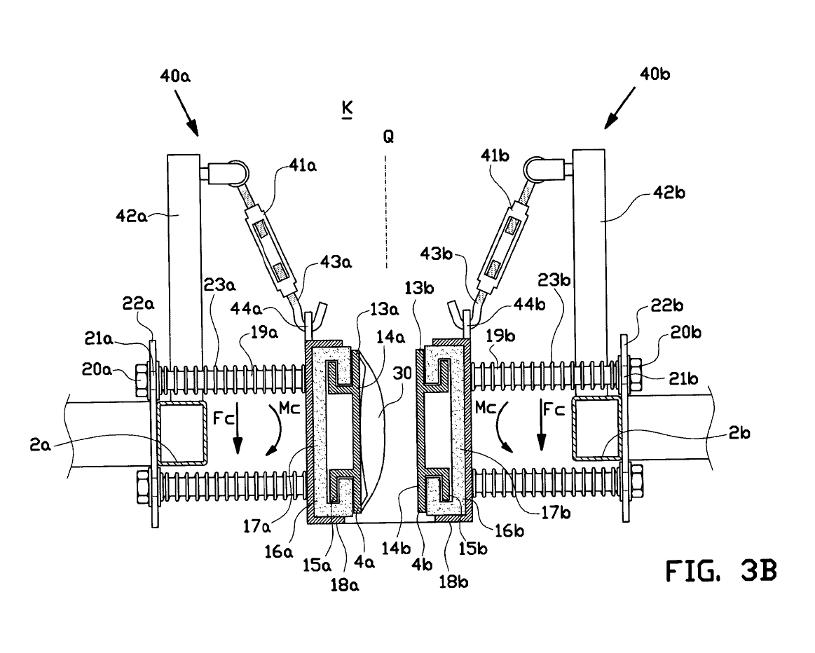

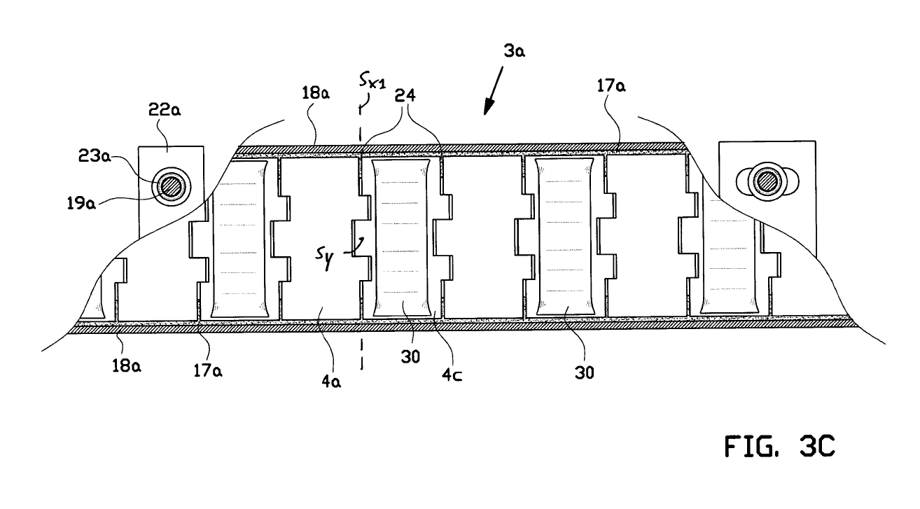

An example of the structure of the conveyors 3a,b is shown in FIGS. 3A and 3B. The conveyors 3a and 3b, in the form of linked belts, comprise links 4a,4b comprising stainless steel metal plates 13a,b (for instance having a length—in conveyance direction—by width of 35 mm by 80 mm) forming even clamping surfaces 14a,b, which face each other in the conveyance track and define intermediate spaces t1, et cetera. On the side facing away from the clamping surfaces, the links 4a,b have been provided with L-shaped lips 15a,b, with which they are guided, in a known manner known per se, in first and second guides 16a,b. The guides 16a,b comprise synthetic (for instance PE-UHMW) channels or guiding elements 17a,b, in which the lips 15a,b are guided and retained against being lifted, and metal holders 18a,b for the guiding elements. The guiding elements can be 20 cm long, 8 cm wide and 2.5 cm thick.

In the conveyance track B in this example, each guide 16a,b is resiliently connected to the frame part 2a,b in question. At their sides facing away from the links 4a,b, the holders 18a,b have each been attached to a pair of pins 19a,b with threaded ends, which pins protrude from the holder and are parallel to each other and perpendicular to plane Q, on both sides of the first and second frame parts 2a,b, and at their outer ends have been provided with stop nuts 20a,b. The pins 19a and 19b on opposite sides are aligned with each other, as can be seen in FIGS. 3A and 3B. The pins 19a,b extend through holes 21a,b in mounting plates 22a,b, that have fixedly been attached to the frame parts 2a,b. Compression springs 23a,b have been arranged between the mounting plates 22a,b and the holders 18a,b, which compression springs with their outer ends support against said plates 22a,b and the holders 18a,b and have been slid onto the pins 19a,b, as a result of which they are kept straight. By turning the nuts 20a,b the distance between the frame parts 2a,b and the holders 18a,b can be adjusted to a certain extent. The pins can be replaced such as by shorter or longer pins, for in the inoperative position of the conveyors (that means without plants) changing the position relative to each other. The compression springs 23a,b can be replaced as well by compression springs with different properties (stronger or less strong), if the plant breed to be processed requires so. Said changes can be executed along the conveyance track, geared to the desires for the specific location of the conveyance track. For instance, instead of enlarging the width of the intermediate space in the track of the lifting station L, a less strong spring could be opted for, enabling movement of the stem in stem direction. Following that, increasing the spring pressure in the leaf-cutting station could be opted for by placing stronger springs on the pins.

As can be seen in FIG. 3A the links 4a,b are mutually connected by first hinged connections 24, allowing a mutual rotation about axes Sx1 and Sy, as known per se.

The guides 16a,b, see FIG. 3A again, in longitudinal direction or conveyance direction, are divided in sections 26a,b having a length of a few links 4, wherein the sections 26a,b each comprise a piece of guide elements 17a,b and a piece of holder 28a,b. The holder pieces 28a,b are mutually connected by second hinged connections 25a,b, allowing a mutual rotation about axis Sx2, locally parallel to Sx1.

In the return track D the guides for the links 4a,b are rigidly, not resiliently attached to the first and second frame parts 2a,b, and not divided in running direction.

The conveyor 3a (not conveyor 3b) includes another particularity, namely regarding links 4c, also see FIG. 3C, that are each time situated between two links 4a, so that a series of links 4a,4c,4a,4c,4a et cetera is obtained. The links 4c are identical to the links 4a, the difference being that they do not have an even clamping surface, but that a rib 30 has been attached to them. The rib may for instance extend over nearly the full link width (considered in a direction transverse to the conveyance direction), for instance over 7.5 cm, and protrude or project from the link plate surface over a height of 1.5 cm. The smallest distance of the rib 30 to the opposing clamping surface 14b, see FIG. 3A, is t5 and smaller than the thickness of the stem of the plants to be processed. This enhances the conveyance and alignment of the plants, preferably into an orientation transverse to the conveyance direction, considered in a vertical plane comprising the conveyance direction. In another embodiment the orienting protrusion on a link is a series of projecting elements arranged in line with each other.

In the curving track K, on the outside, tensile connections 40a,b have furthermore been arranged between the frame 2 and the conveyors 3a,b in their conveyance track, which form a tensile connection between outriggers 42a,b that are fixed to the frame parts 2a,b, and the holders 18a,b. The tensile connections 40a,b can be adjusted as to length, for instance using a turnbuckle, and are hinged to the outriggers 42a,b and rotatably connected to small plates 44a,b by a hook 43a,b, which small plates are attached to the edge of the holders 18a,b on the convex side of the curving track K. This enhances a parallel alignment of the clamping surfaces 14a,b in the curving track, and tilting (moment Mc) due to centripetal forces Fc is counteracted, see FIG. 3B.

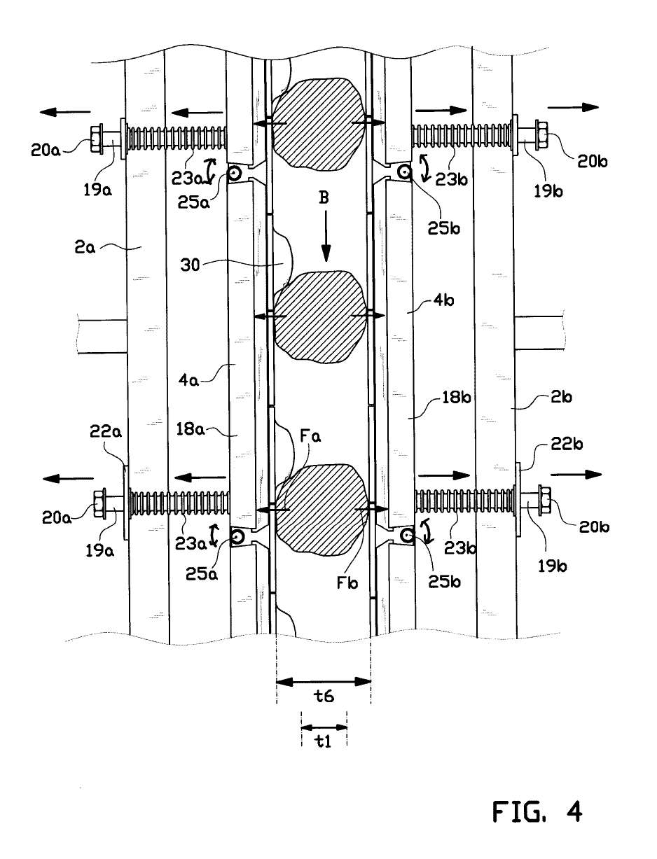

The resilient support of the conveyors 3a,b in the conveyance track B enables reliable conveyance of stems of different thicknesses, without the plants getting damaged to an unacceptable extent. FIG. 4 shows that the stems (for instance having a thickness in the range of 3-5 cm) are thicker than the minimum width t1 of the intermediate space, namely t6. The stems exert a pressure force on the links 4a,b of Fa,b, which forces are transferred to the pins 19a,b via the links 4a,b, guiding elements 17a,b and holders 18a,b. These pins are pushed to the outside, through the plates 22a,b, while pushing in the springs 23a,b until an equilibrium has been reached. Variations in the stem thickness can easily be compensated for by the hinging motion about the second hinge axes between the consecutive holders 18a,b.

If it is opted for that the ribs 30 contact the opposing clamping surface when no plants have been engaged by the conveyors, then in the example t0 can be approximately 1.7 cm, t1 be 1.5 cm (height of ribs 30), t2 can be approximately 5 cm (equal to or larger than the largest stem thickness), and t4 be 1.5 cm just like t1. In FIGS. 4 t5 and t6 can then vary, depending on the thickness of the stem in question, in case of a stem thickness of 3 cm for instance 1.5 cm and 3 cm.

By placing the springs on the side of the links 4a,b that faces away from the intermediate space, relatively considerable room is available for the spring motion. There will also be freedom in adjusting the design of the pins and the springs to another, for instance larger spring travel length in order to process a larger stem thickness, or to choose another spring force. The second hinged connections 25a,b allow a variation between differences in thickness of the stems of consecutive plants.

The above description is included to illustrate the operation of preferred embodiments of the invention and not to limit the scope of the invention. Starting from the above explanation many variations that fall within the spirit and scope of the present invention will be evident to an expert.

1. Device for harvesting vegetable plants from the land, in particular vegetable plants having a stem, more in particular vegetable plants having a stem and a crown, such as broccoli, comprising:
a frame;
first and second conveyors arranged on the frame, which conveyors have been positioned for in a conveyance track conveying vegetable plants that have been separated from the land to one or more processing stations for said vegetable plants, said processing stations being arranged on the frame;
wherein the first and second conveyors each comprise a series of links, wherein the links within a series are connected to each other by first hinged connections;
wherein the links have clamping surfaces and in the conveyance track the clamping surfaces of the first and second conveyors face each other for keeping the vegetable plants, in particular their stems, clamped in between them in an intermediate space formed by the opposing clamping surfaces of the links of the first and second conveyors,
wherein, in the conveyance track, the links of at least one of the conveyors, preferably both conveyors, are resiliently movable relative to the frame in a direction transverse to the clamping surfaces.

2. Device according to claim 1,
wherein spring devices have been arranged in the conveyance track, in the area between the links and the frame, for in a resilient manner pushing the opposing clamping surfaces of the links of the first and second conveyors in a direction towards each other.

3. Device according to claim 1,
wherein the links have been provided with guiding members and the device further comprises first and second guides for guiding the guiding members of the links of the first and second conveyors, respectively.

4. Device according to claim 3,
wherein spring devices have been arranged in the conveyance track, in the area between the links and the frame, for in a resilient manner pushing the opposing clamping surfaces of the links of the first and second conveyors in a direction towards each other and
wherein, when considered in conveyance direction, the spring devices are relatively stationary with the respective one of the first and the second guides.

5. Device according to claim 4,
wherein the spring devices are active between the frame and the respective one of the first and the second guides.

6. Device according to claim 5,
wherein the first and/or second conveyors have been arranged on first and/or second frame parts, respectively, that are situated on the side of the first and second conveyors, which side faces away from the intermediate space,
wherein the spring devices are active between the respective one of the first and second frame parts and the respective one of the first and the second guides, respectively.

7. Device according to claim 1,
wherein the minimum width of the intermediate space between the opposing clamping surfaces of the links of the first and second conveyors is adjustable.

8. Device according to claim 7, wherein the action of the spring devices is bounded by stops for keeping the intermediate space at a minimum width, which stops preferably are adjustable.

9. Device according to claim 1,
wherein the spring devices comprise springs, in particular compression springs, wherein, preferably, the springs are parallel to rods that are concentric with the springs, for orienting and guiding the springs, the rods preferably being pins accommodated in the springs.

10. Device according to claim 1, wherein the first and/or second frame parts comprise a beam extending parallel to the respective one of the first and second conveyors, respectively, wherein the spring devices comprise pairs of springs that have been arranged adjacent to each other, on both sides of the beam of the frame part in question.

11. Device according to claim 1,
wherein in the conveyance track, when considered in conveyance direction, the first and/or the second guides have been divided into consecutive guide sections, wherein the consecutive guide sections are connected to each other by second hinged connections, wherein the hinge axes of the second hinged connections and the hinge axes of the first hinged connections of the links present at the location of the second hinged connections in question are at least almost parallel to each other.

12. Device according to claim 11,
wherein the guide sections of the first and/or the second guides each comprise guide elements and holders for them, wherein the second hinged connections have been arranged between consecutive holders.

13. Device according to claim 11,
wherein several of the sections mentioned, preferably all sections mentioned, of the first and/or the second guides have each been connected to the frame by means of a spring device of their own.

14. Device according to claim 4,
wherein the spring devices comprise first spring devices which are active between the frame and the first guide and second spring devices which are active between the frame and the second guide,
wherein the first and second spring devices are arranged on opposite sides of the conveyance track and in line with one another.

15. Device according to claim 1,
wherein the conveyance track comprises a curve section, in which the first and second clamping surfaces follow curved paths in mutually parallel planes,
wherein extra connections have been arranged between the frame and the first and/or the second guides, for counteracting a centripetal force exerted on the first and/or the second guides by the moving first and/or second conveyors, wherein the extra connections preferably are tensile connections and preferably are adjustable and/or preferably are situated on the convex side of the curving track,

16. Device according to claim 1,
wherein the links of at least one of the conveyors at the side of its clamping surfaces, preferably on the clamping surfaces, have been provided with protrusions, such as ribs, projecting into the intermediate space, for orienting the stems, wherein, preferably, the protrusions, such as ribs, extend in a direction transverse to the conveyance direction.

17. Device according to claim 16, wherein the protrusions have been provided on one of either conveyors only.

18. Device according to claim 2,
comprising a positioning station for positioning the crown of the vegetable plants at the wanted level relative to the conveyors, wherein at the positioning station the conveyance track comprises a positioning sub-track, where the width of the intermediate space between the opposing clamping surfaces is enlarged relative to sub-tracks of the conveyance track that are situated upstream from the positioning station, for allowing a movement of the vegetable plants at that location in stem direction and/or where the resilience of the spring devices is lower than the resilience of the spring devices in sub-tracks of the conveyance track that are situated upstream from the positioning station.

19. Device according to claim 18,
comprising a leaf-cutting station and/or a crown-cutting station situated downstream from the positioning station,
wherein at the leaf-cutting station the conveyance track has a leaf-cutting sub-track and at the location of the crown-cutting station has a crown-cutting sub-track, at which locations the intermediate space between opposing clamping surfaces is smaller than in the positioning sub-track, for keeping the stems clamped and/or at which locations the resilience of the spring devices is greater than the resilience of the spring devices in the positioning sub-track.

20. Device according to claim 1,
wherein the conveyance track comprises a horizontally extending feeding sub-track, an upwardly curved ascending sub-track and a horizontally extending processing sub-track, wherein the processing sub-track preferably is situated straight above the feeding sub-track—wherein at the location of the feeding sub-track a stem-cutting station has been arranged on the frame, for severing the stem in order to separate the vegetable plant from the land, and—wherein a positioning station, a leaf-cutting station and a crown-cutting station have been arranged on the frame at the location of the processing sub-track wherein, preferably, the conveyors each have a return track that is substantially parallel and opposite to the conveyance track.
